(19) United States
(12) Patent Application Publication
(10) Pub. No.: US 2020/0315128 A1
(43) Pub. Date: Oct. 8, 2020

(54) All-In-One Cat Housing Apparatus

(71) Applicant: Kim Becherer, Springboro, OH (US)

(72) Inventor: Kim Becherer, Springboro, OH (US)

(21) Appl. No.: 16/373,768

(22) Filed: Apr. 3, 2019

(51) Int. Cl. A01K 1/03; A01K 13/00; A01K 5/01; A01K 1/01

(52) U.S. Cl. CPC A01K 1/033; A01K 13/004; A01K 1/0114; A01K 1/011; A01K 5/0114

(57) ABSTRACT

An all-in-one cat housing apparatus for providing living, eating, and bathroom space for a cat includes a housing structure having a top side, a bottom side, a front side, a rear side, a left side, a right side, and an inside. A plurality of apertures extends through to the inside. An upper divider is coupled within the inside to form an upper compartment between the upper divider and the top side. A lower divider is coupled within the inside to form a middle compartment between the lower divider and the upper divider and a bottom compartment between the lower divider and the bottom side. A drawer is coupled within the upper compartment. The drawer is slidable through the top front aperture and is configured to receive cat litter to function as a litter box. A scratching post is coupled to the top side of the housing structure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to cat houses and more particularly pertains to a new cat house for providing living, eating, and bathroom space for a cat.

### BRIEF SUMMARY OF THE INVENTION

An embodiment of the disclosure meets the needs presented above by generally comprising a housing structure having a top side separated from a bottom side, a front side separated from a rear side, and a left side separated from a right side. The top side, the bottom side, the front side, the rear side, the left side, and the right side form an inside. The front side has a top front aperture, a middle front aperture, and a bottom front aperture each extending through to the inside. The left side has a middle side aperture and a bottom side aperture each extending through to the inside. The rear side has a top rear aperture and a middle rear aperture each extending through to the inside. An upper divider is coupled to each of the front side, the rear side, the left side, and the right side. The upper divider is coupled parallel to the top side between the top front aperture and the middle front aperture to form an upper compartment between the upper divider and the top side. A lower divider is coupled to each of the front side, the rear side, the left side, and the right side. The lower divider is coupled parallel to the bottom side between the bottom front aperture and the middle front aperture to form a middle compartment between the lower divider and the upper divider and a bottom compartment between the lower divider and the bottom side. A drawer is coupled to the housing structure within the upper compartment. The drawer is slidable through the top front aperture and is configured to receive cat litter to function as a litter box. A scratching post is coupled to the top side of the housing structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of an all-in-one cat housing apparatus according to an embodiment of the disclosure.

FIG. 2 is an isometric view of an embodiment of the disclosure.

FIG. 3 is a side elevation view of an embodiment of the disclosure.

FIG. 4 is a front elevation view of an embodiment of the disclosure.

FIG. 5 is a rear elevation view of an embodiment of the disclosure.

FIG. 6 is a detail view of an embodiment of the disclosure.

FIG. 7 is an isometric view of an embodiment of the disclosure.

FIG. 8 is an isometric view of an embodiment of the disclosure.

FIG. 9 is an isometric view of an embodiment of the disclosure.

FIG. 10 is an isometric view of an embodiment of the disclosure.

### DETAILED DESCRIPTION OF THE INVENTION

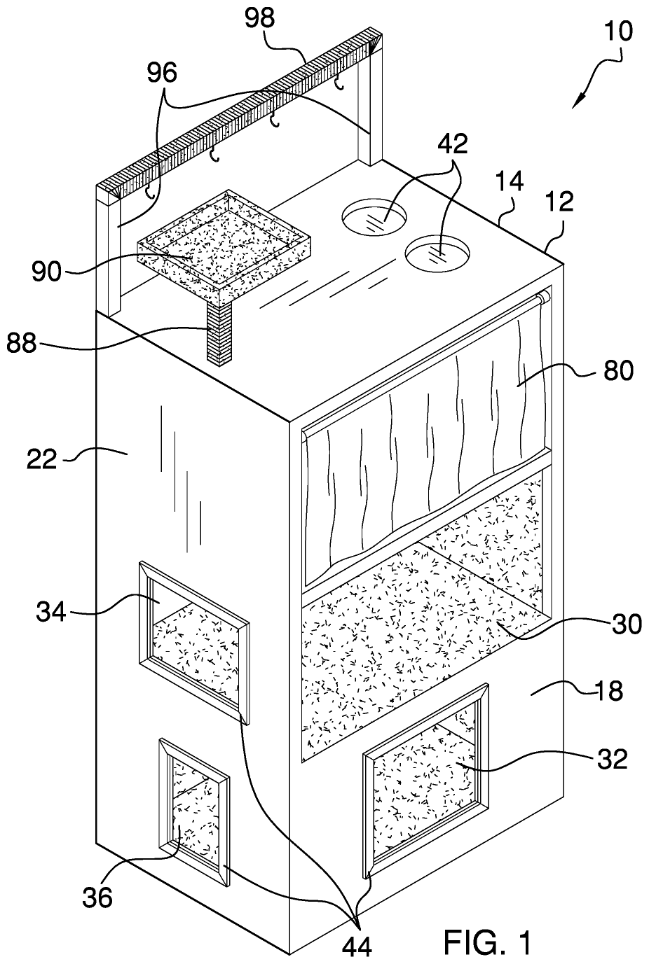

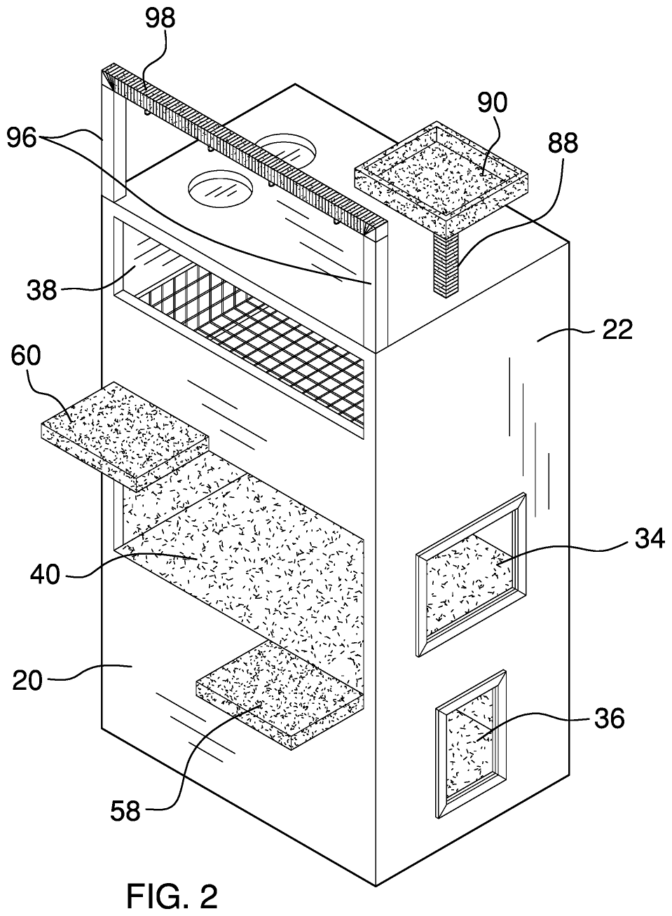

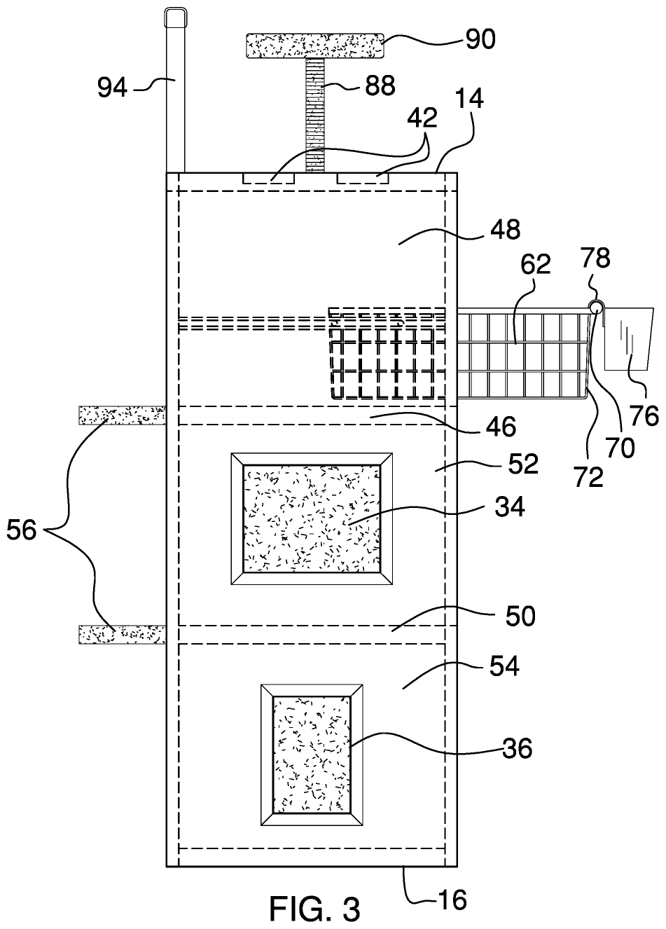

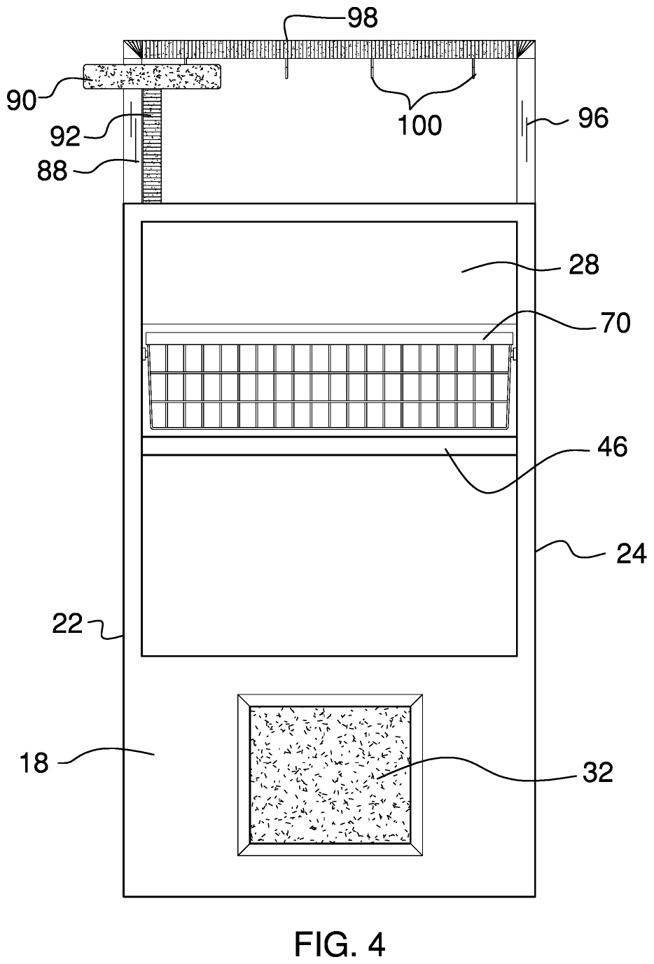

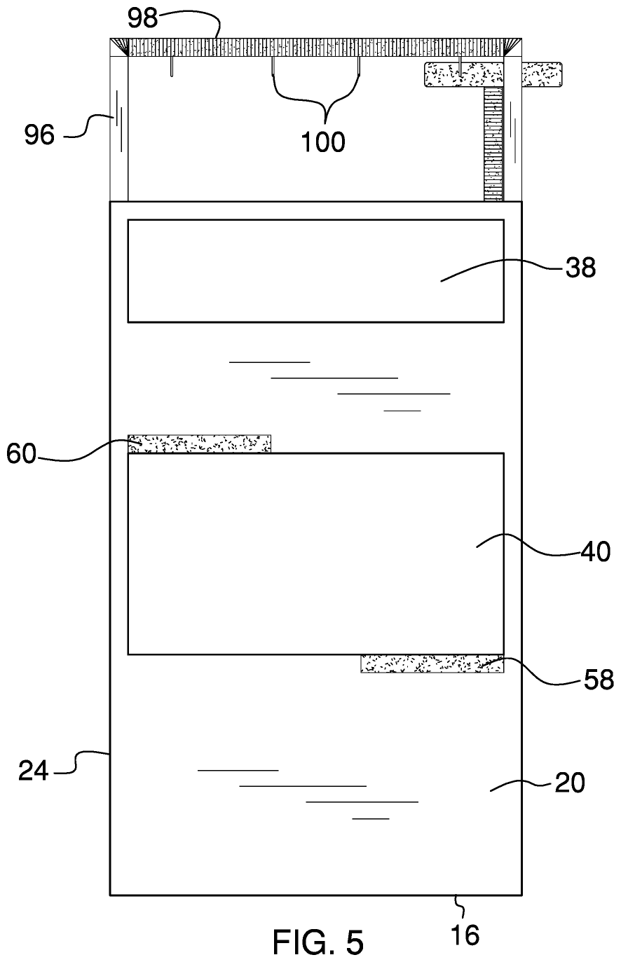

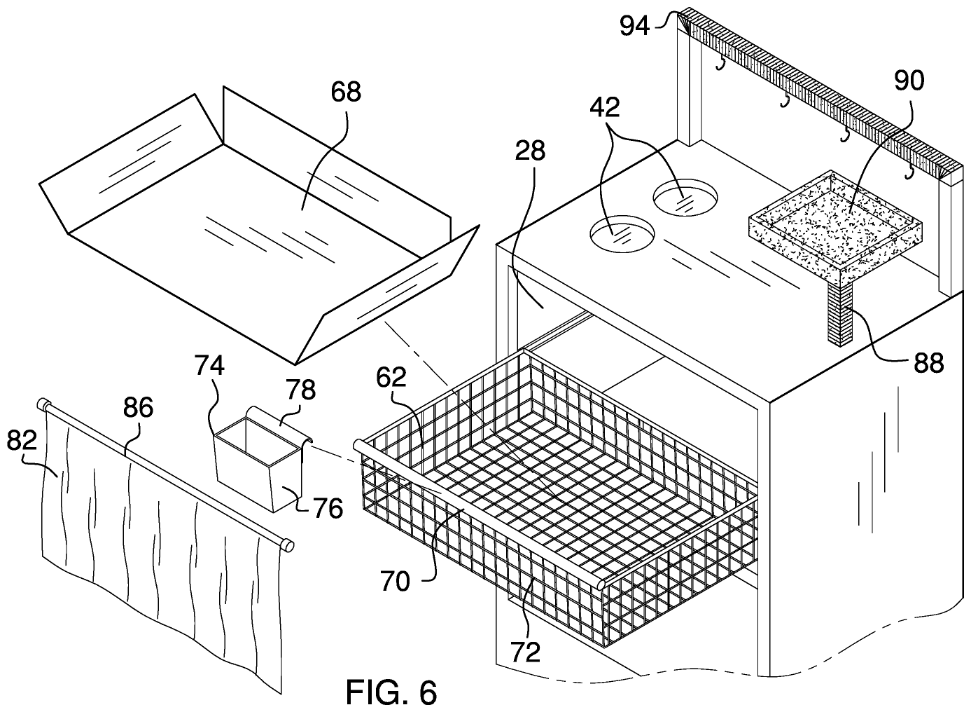

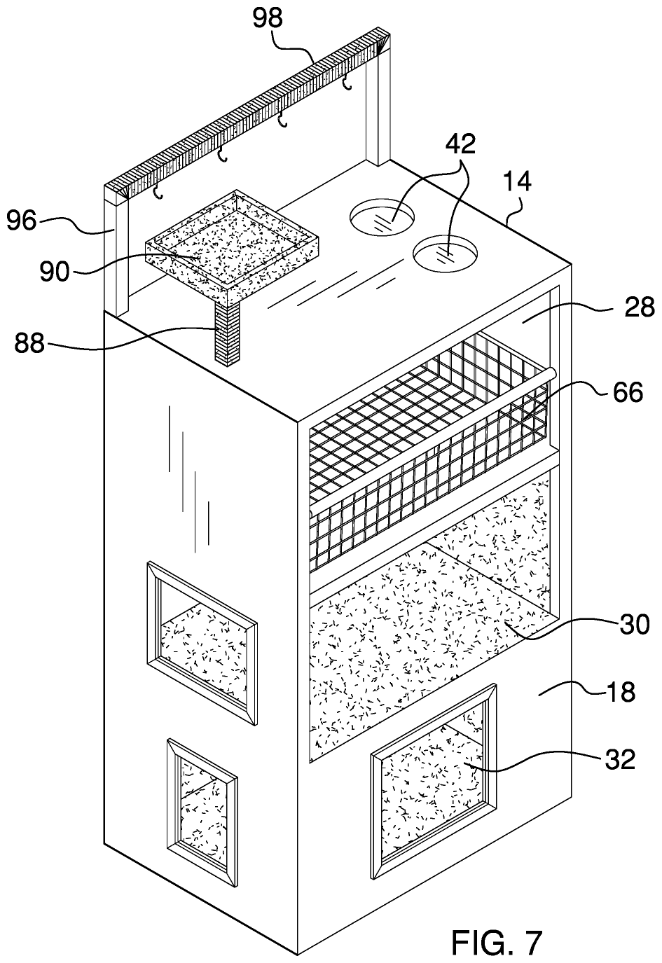

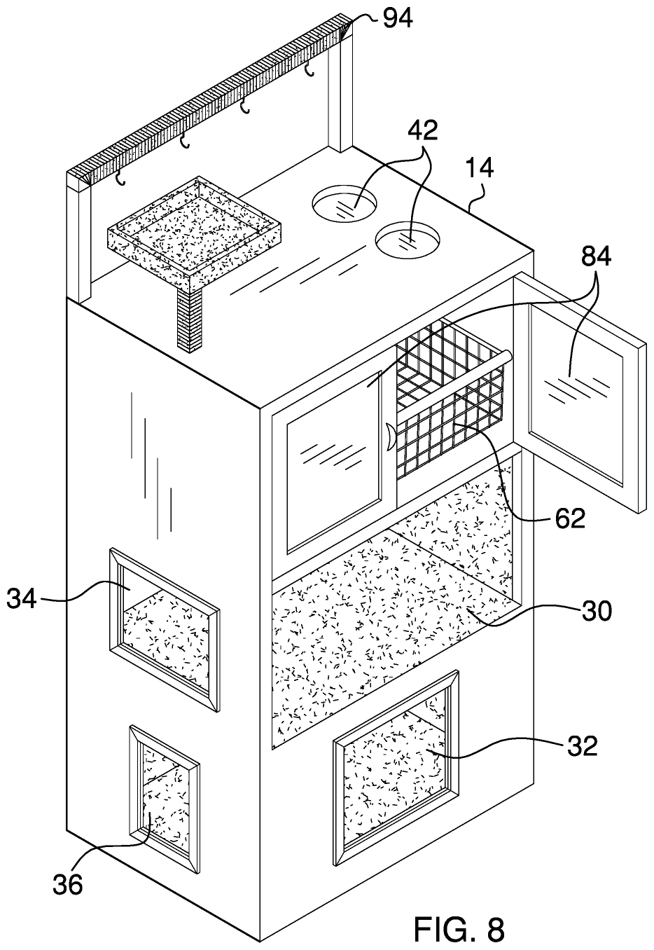

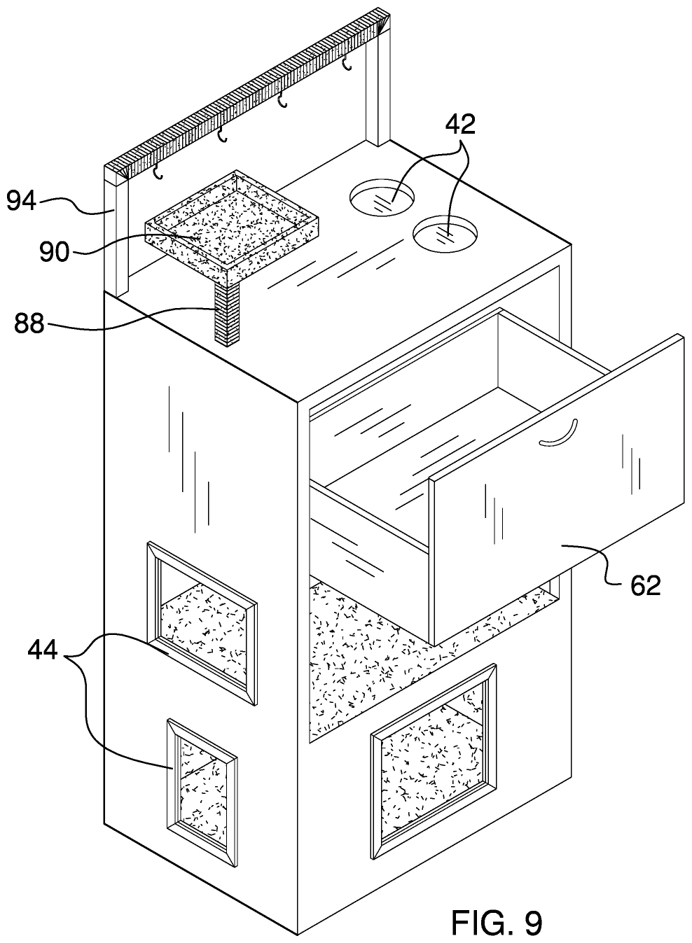

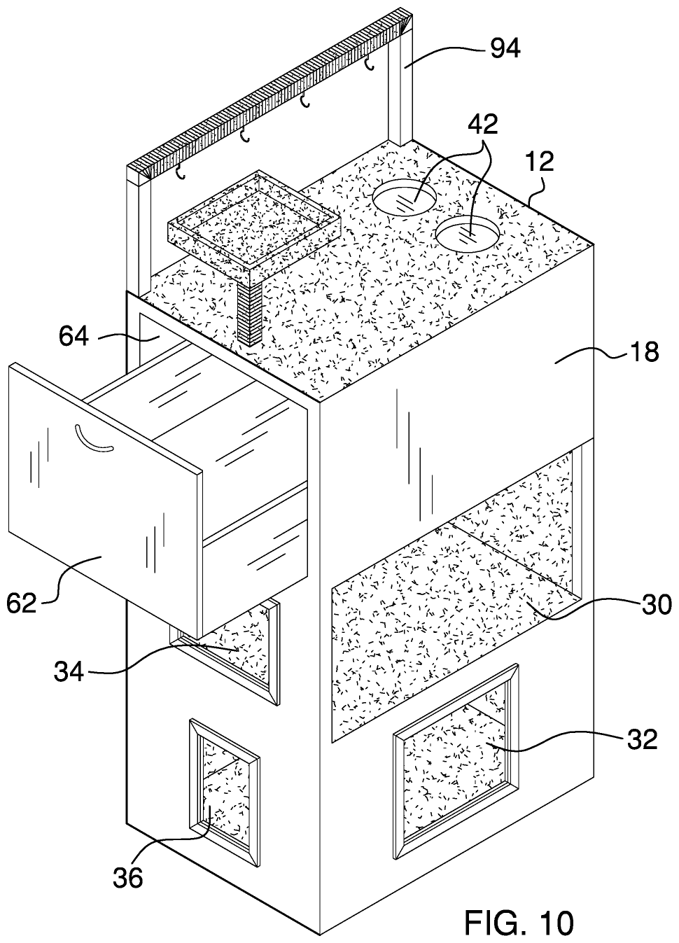

With reference now to the drawings, and in particular to FIGS. 1 through 10 thereof, a new cat house embodying the principles and concepts of an embodiment of the disclosure and generally designated by the reference numeral 10 will be described.

As best illustrated in FIGS. 1 through 10, the all-in-one cat housing apparatus 10 generally comprises a housing structure 12 having a top side 14 separated from a bottom side 16, a front side 18 separated from a rear side 20, and a left side 22 separated from a right side 24. The top side 14, the bottom side 16, the front side 18, the rear side 20, the left side 22, and the right side 24 form an inside 26. The front side 18 has a top front aperture 28, a middle front aperture 30, and a bottom front aperture 32 each extending through to the inside 26. The left side 22 has a middle side aperture 34 and a bottom side aperture 36 each extending through to the inside 26. The rear side 20 may have a top rear aperture 38 and a middle rear aperture 40 each extending through to the inside 26. The top side 14 may have a pair of dish recessions 42. Each of the pair of dish recessions 42 is configured to receive a food or water dish to prevent them from being knocked off the housing structure 12. The top side 14 may be carpeted. There may be a plurality of aperture frames 44 coupled to the housing structure 12. The plurality of aperture frames 44 is coupled to each of the bottom front aperture 32, the middle side aperture 34, and the bottom side aperture 36.

An upper divider 46 is coupled to each of the front side 18, the rear side 20, the left side 22, and the right side 24. The upper divider 46 is coupled parallel to the top side 14 between the top front aperture 28 and the middle front aperture 30 to form an upper compartment 48 between the upper divider 46 and the top side 14. A lower divider 50 is coupled to each of the front side 18, the rear side 20, the left side 22, and the right side 24. The lower divider 50 is coupled parallel to the bottom side 16 between the bottom front aperture 32 and the middle front aperture 30 to form a middle compartment 52 between the lower divider 50 and the upper divider 46 and a bottom compartment 54 between the lower divider 50 and the bottom side 16. Each of the middle compartment 52 and the bottom compartment 54 may be carpeted.

There may be a pair of steps 56 coupled to the housing structure 12. The pair of steps 56 comprises a lower step 58 coupled to the rear side 20 below the middle rear aperture 40 and an upper step 60 coupled to the rear side 20 above the middle rear aperture 40 and below the top rear aperture 38. The pair of steps 56 provides easier access for a cat to reach the middle compartment 52, the upper compartment 48, and the top side 14. The pair of steps 56 may be carpeted.

A drawer 62 is coupled within the upper compartment 48. The drawer is slidable through the top front aperture 28. The housing structure 12 may alternatively have a top side aperture 64 extending through to the upper compartment 48, in which case the drawer 62 is slidable through the top side aperture 64. The drawer 62 is configured to receive cat litter to function as a litter box. The drawer 62 may be wire mesh 66, in which case a drawer liner 68 is removably disposed within the drawer 62. A draw bar 70 may be coupled to an upper front edge 72 of the drawer. A litter bag box 74 has an open-topped box 76 and a drawer hook 78 coupled to the open-topped box 76. The drawer hook 78 is selectively engageable with the draw bar 70. The open-topped box 76 is configured to receive a plastic litter bag to collect soiled cat litter. A drawer cover 80 may be coupled to the top front aperture 28. The drawer cover 80 is may be one of a curtain 82 and a pair of doors 84. The curtain 82 has an extension rod 86 that is selectively engageable with the top front aperture 28.

A scratching post 88 is coupled to the top side 14 of the housing structure. The scratching post 88 may be twine wrapped. A day bed 90 may be coupled to a top end 92 of the scratching post. The day bed 90 may be carpeted. There may be a rear bar 94 coupled to the housing structure 12. The rear bar 94 has a pair of vertical posts 96 coupled to the top side 14 adjacent the rear side 20 and a cross post 98 extending between the pair of vertical posts 96. The cross post 98 is a second scratching post and may be twine wrapped. A plurality of hanger hooks 100 may be coupled to the cross post 98. Each of the plurality of hanger hooks 100 is configured to receive a pet toy or care accessory.

In use, the cat may use the top side 14 as an eating and playing area, the upper compartment 48 as a restroom, the middle compartment 52, as rest area, and the bottom compartment 54 as a sleeping area. To change the cat litter the drawer 62 is slid out of the housing structure 12 and the litter bag box 74 is coupled to the draw bar 70 to support the plastic litter bag while removing soiled litter.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An all-in-one cat housing apparatus comprising:
a housing structure, the housing structure having a top side separated from a bottom side, a front side separated from a rear side, and a left side separated from a right side, the top side, the bottom side, the front side, the rear side, the left side, and the right side forming an inside, the front side having a top front aperture, a middle front aperture, and a bottom front aperture each extending through to the inside, the left side having a middle side aperture and a bottom side aperture each extending through to the inside;
an upper divider coupled to the housing structure, the upper divider being coupled to each of the front side, the rear side, the left side, and the right side, the upper divider being coupled parallel to the top side between the top front aperture and the middle front aperture, the upper divider forming an upper compartment between the upper divider and the top side;
a lower divider coupled to the housing structure, the lower divider being coupled to each of the front side, the rear side, the left side, and the right side, the lower divider being coupled parallel to the bottom side between the bottom front aperture and the middle front aperture, the lower divider forming a middle compartment between the lower divider and the upper divider and a bottom compartment between the lower divider and the bottom side;
a drawer coupled to the housing structure, the drawer being coupled within the upper compartment, the drawer being slidable through the top front aperture, the drawer being configured to receive cat litter to function as a litter box; and
a scratching post coupled to the housing structure, the scratching post being coupled to the top side.

2. The all-in-one cat housing apparatus of claim 1 further comprising the rear side of the housing structure having a top rear aperture and a middle rear aperture, the top rear aperture extending through to the upper compartment and the middle rear aperture extending through to the middle compartment.

3. The all-in-one cat housing apparatus of claim 1 further comprising the top side having a pair of dish recessions, each of the pair of dish recessions being configured to receive a food or water dish.

4. The all-in-one cat housing apparatus of claim 1 further comprising a day bed coupled to the scratching post, the day bed being coupled to a top end of the scratching post.

5. The all-in-one cat housing apparatus of claim 4 further comprising a rear bar coupled to the housing structure, the rear bar having a pair of vertical posts coupled to the top side and a cross post extending between the pair of vertical posts, the cross post being a second scratching post.

6. The all-in-one cat housing apparatus of claim 5 further comprising a plurality of hanger hooks coupled to the cross post, each of the plurality of hanger hooks being configured to receive a pet toy or care accessory.

7. The all-in-one cat housing apparatus of claim 1 further comprising a drawer cover coupled to the housing structure, the drawer cover being coupled to the top front aperture.

8. The all-in-one cat housing apparatus of claim 7 further comprising the drawer cover being one of a curtain and a pair of doors, the curtain having an extension rod.

9. The all-in-one cat housing apparatus of claim 2 further comprising a pair of steps coupled to the housing structure, the pair of steps comprising a lower step coupled to the rear side below the middle rear aperture and an upper step coupled to the rear side above the middle rear aperture and below the top rear aperture.

10. The all-in-one cat housing apparatus of claim 1 further comprising a draw bar coupled to the drawer, the draw bar being coupled to an upper front edge of the drawer.

11. The all-in-one cat housing apparatus of claim 10 further comprising a litter bag box, the litter bag box having an open-topped box and a drawer hook coupled to the open-topped box, the drawer hook being selectively engageable with the draw bar, the open-topped box being configured to receive a plastic litter bag to collect soiled cat litter.

12. The all-in-one cat housing apparatus of claim 1 further comprising the drawer being wire mesh.

13. The all-in-one cat housing apparatus of claim 12 further comprising a drawer liner, the drawer liner being removably disposed within the drawer.

14. The all-in-one cat housing apparatus of claim 1 further comprising a plurality of aperture frames coupled to the housing structure, the plurality of aperture frames being coupled to each of the bottom front aperture, the middle side aperture, and the bottom side aperture.

15. The all-in-one cat housing apparatus of claim 5 further comprising each of the scratching post and the cross post being twine wrapped.

16. The all-in-one cat housing apparatus of claim 15 further comprising each of the top side, the middle compartment, the bottom compartment, the pair of steps, and the day bed being carpeted.

17. An all-in-one cat housing apparatus comprising:
a housing structure, the housing structure having a top side separated from a bottom side, a front side separated from a rear side, and a left side separated from a right side, the top side, the bottom side, the front side, the rear side, the left side, and the right side forming an inside, the front side having a top front aperture, a middle front aperture, and a bottom front aperture each extending through to the inside, the left side having a middle side aperture and a bottom side aperture each extending through to the inside, the rear side of the housing structure having a top rear aperture and a middle rear aperture each extending through to the inside, the top side having a pair of dish recessions, each of the pair of dish recessions being configured to receive a food or water dish, the top side being carpeted;
a plurality of aperture frames coupled to the housing structure, the plurality of aperture frames being coupled to each of the bottom front aperture, the middle side aperture, and the bottom side aperture;
an upper divider coupled to the housing structure, the upper divider being coupled to each of the front side, the rear side, the left side, and the right side, the upper divider being coupled parallel to the top side between the top front aperture and the middle front aperture, the upper divider forming an upper compartment between the upper divider and the top side;
a lower divider coupled to the housing structure, the lower divider being coupled to each of the front side, the rear side, the left side, and the right side, the lower divider being coupled parallel to the bottom side between the bottom front aperture and the middle front aperture, the lower divider forming a middle compartment between the lower divider and the upper divider and a bottom compartment between the lower divider and the bottom side, each of the middle compartment and the bottom compartment being carpeted;
a pair of steps coupled to the housing structure, the pair of steps comprising a lower step coupled to the rear side below the middle rear aperture and an upper step coupled to the rear side above the middle rear aperture and below the top rear aperture, the pair of steps being carpeted;
a drawer coupled to the housing structure, the drawer being coupled within the upper compartment, the drawer being slidable through the top front aperture, the drawer being configured to receive cat litter to function as a litter box;
a draw bar coupled to the drawer, the draw bar being coupled to an upper front edge of the drawer;
a litter bag box, the litter bag box having an open-topped box and a drawer hook coupled to the open-topped box, the drawer hook being selectively engageable with the draw bar, the open-topped box being configured to receive a plastic litter bag to collect soiled cat litter;
a drawer cover coupled to the housing structure, the drawer cover being coupled to the top front aperture, the drawer cover being one of a curtain and a pair of doors, the curtain having an extension rod;
a scratching post coupled to the housing structure, the scratching post being coupled to the top side, the scratching post being twine wrapped;
a day bed coupled to the scratching post, the day bed being coupled to a top end of the scratching post, the day bed being carpeted;
a rear bar coupled to the housing structure, the rear bar having a pair of vertical posts coupled to the top side and a cross post extending between the pair of vertical posts, the cross post being a second scratching post, the cross post being twine wrapped; and
a plurality of hanger hooks coupled to the rear bar, the plurality of hanger hooks being coupled to the cross post, each of the plurality of hanger hooks being configured to receive a pet toy or care accessory.
